(19) United States
(12) Patent Application Publication
(10) Pub. No.: US 2026/0249744 A1
(43) Pub. Date: Aug. 27, 2026

(54) TECHNIQUES FOR DETERMINING FUEL CELL SYSTEM POWER AND OPERATION MODE TO IMPROVE ENERGY EFFICIENCY DURING REGENERATION IN A FUEL CELL ELECTRIC VEHICLE

(71) Applicant: FCA US LLC, Auburn Hills, MI (US)

(72) Inventors: Xin Diao, Auburn Hills, MI (US); Xuanqi Liu, Poissy (FR); Silvio Maetzke, Auburn Hills, MI (US); Sampath Mandala, Auburn Hills, MI (US)

(21) Appl. No.: 19/059,385

(22) Filed: Feb. 21, 2025

(51) Int. Cl. B60L 58/30; B60L 3/12; B60L 7/10; H01M 8/04537; H01M 8/04858

(52) U.S. Cl. CPC B60L 58/30; B60L 3/12; H01M 8/04604; H01M 8/0494; B60L 7/10

(57) ABSTRACT

A control system and method for a fuel cell electric vehicle (FCEV) including a fuel cell system and a high voltage battery system include a set of sensors configured to determine a regenerative power request for the FCEV, wherein the regenerative power request corresponds to kinetic energy of the FCEV being converted into electrical energy via a motor-generator unit (MGU) of the FCEV and a controller configured to compare the regenerative power request to a plurality of power limits associated with operation of the fuel cell system, wherein the fuel cell system is configured to operate in each of run, standby, and off operation modes, and when the regenerative power request exceeds the plurality of power limits, reduce a power request for the fuel cell system to zero and command an operation mode request for the fuel cell system to change from run to standby.

### FIELD

The present application generally relates to fuel cell electric vehicles (FCEVs) and, more particularly, to techniques for determining fuel cell system power and operation mode to improve energy efficiency during regeneration in an FCEV.

### BACKGROUND

Some fuel cell electric vehicles (FCEVs) are configured such that a fuel cell system generates electrical energy for supporting a high voltage bus and recharging a high voltage battery system. The high voltage battery system is also configured to be recharged during regeneration operation (i.e., coasting/braking regeneration) where the kinetic energy of the FCEV is configured to be converted back into electrical energy (e.g., via a motor-generator unit, or MGU). Thus, instances could arise where the kinetic energy of the FCEV cannot be fully obtained during a regeneration event due to the fuel cell system charging the high voltage battery system at or near its maximum capacity or state of charge (SOC). Fuel cell systems, however, are not configured to be quickly turned on/off or to quickly have their output power reduced, as there are startup/shutdown procedures and excessive on/off operations could damage or degrade the fuel cell stack membranes over time. Accordingly, while such conventional FCEV control systems do work for their intended purpose, there exists an opportunity for improvement in the relevant art.

### SUMMARY

According to one example aspect of the invention, a fuel cell control system for a fuel cell electric vehicle (FCEV) including a fuel cell system and a high voltage battery system is presented. In one exemplary implementation, the fuel cell control system comprises a set of sensors configured to determine a regenerative power request for the FCEV, wherein the regenerative power request corresponds to kinetic energy of the FCEV being converted into electrical energy via a motor-generator unit (MGU) of the FCEV and a control system configured to compare the regenerative power request to a plurality of power limits associated with operation of the fuel cell system, wherein the fuel cell system is configured to operate in each of run, standby, and off operation modes, and when the regenerative power request exceeds the plurality of power limits, reduce a power request for the fuel cell system to zero and command an operation mode request for the fuel cell system to change from run to standby.

In some implementations, the control system is further configured to determine whether the standby operation mode of the fuel cell system is currently available. In some implementations, the control system is further configured to, when the standby operation mode of the fuel cell system is not currently available and the regenerative power request exceeds the plurality of power limits, reduce the power request for the fuel cell system to zero and command the operation mode request for the fuel cell system to change from run to off.

In some implementations, the plurality of power limits are each based on a combination of at least two of (i) a maximum charging power limit for the high voltage battery system, (ii) an actual power generated by the fuel cell system, (iii) a minimum power limit to be generated by the fuel cell system, and (iv) a mode transition power cost threshold. In some implementations, the control system is configured to initially operate the fuel cell system in the run operation mode with a power request greater than zero.

In some implementations, the control system is further configured to, when the regenerative power request is less than or equal to a first power difference between the maximum charging power limit for the high voltage battery system and the actual power generated by the fuel cell system, maintain the power request and the run operation mode of the fuel cell system. In some implementations, the control system is further configured to, when the regenerative power request is (i) greater than the first power difference and (i) less than or equal to a sum of the first power difference and the mode transition power cost threshold, maintain the run operation mode of the fuel cell system and reduce the power request for the fuel cell system to a second power difference between the maximum charging power limit for the high voltage battery system and the regenerative power request.

In some implementations, the control system is further configured to, when the regenerative power request is greater than a sum of the first power difference and the mode transition power cost threshold, reduce the power request for the fuel cell system to zero and change the operation mode request for the fuel cell system from run to standby or off based on an availability of the standby operation mode. In some implementations, the standby operation mode of the fuel cell system involves the fuel cell system remaining partially operational, by maintaining a minimum flow of hydrogen and air to a fuel cell stack, but not actively producing electricity.

According to another example aspect of the invention, a control method for an FCEV including a fuel cell system and a high voltage battery system is presented. In one exemplary implementation, the control method comprises providing a set of sensors configured to determine a regenerative power request for the FCEV, wherein the regenerative power request corresponds to kinetic energy of the FCEV being converted into electrical energy via an MGU of the FCEV, comparing, by a control system of the FCEV, the regenerative power request to a plurality of power limits associated with operation of the fuel cell system, wherein the fuel cell system is configured to operate in each of run, standby, and off operation modes, and when the regenerative power request exceeds the plurality of power limits, reducing, by the control system, a power request for the fuel cell system to zero and commanding, by the control system, an operation mode request for the fuel cell system to change from run to standby.

In some implementations, the control method further comprises determining, by the control system, whether the standby operation mode of the fuel cell system is currently available. In some implementations, the control method further comprises when the standby operation mode of the fuel cell system is not currently available and the regenerative power request exceeds the plurality of power limits, reducing, by the control system, the power request for the fuel cell system to zero and commanding, by the control system, the operation mode request for the fuel cell system to change from run to off.

In some implementations, the plurality of power limits are each based on a combination of at least two of (i) a maximum charging power limit for the high voltage battery system, (ii) an actual power generated by the fuel cell system, (iii) a minimum power limit to be generated by the fuel cell system, and (iv) a mode transition power cost threshold. In some implementations, the control method further comprises initially operating, by the control system, the fuel cell system in the run operation mode with a power request greater than zero.

In some implementations, the control method further comprises when the regenerative power request is less than or equal to a first power difference between the maximum charging power limit for the high voltage battery system and the actual power generated by the fuel cell system, maintaining, by the control system, the power request and the run operation mode of the fuel cell system. In some implementations, the control method further comprises when the regenerative power request is (i) greater than the first power difference and (i) less than or equal to a sum of the first power difference and the mode transition power cost threshold, maintaining, by the control system, the run operation mode of the fuel cell system and reducing, by the control system, the power request for the fuel cell system to a second power difference between the maximum charging power limit for the high voltage battery system and the regenerative power request.

In some implementations, the control method further comprises when the regenerative power request is greater than a sum of the first power difference and the mode transition power cost threshold, reducing, by the control system, the power request for the fuel cell system to zero and changing, by the control system, the operation mode request for the fuel cell system from run to standby or off based on an availability of the standby operation mode. In some implementations, the standby operation mode of the fuel cell system involves the fuel cell system remaining partially operational, by maintaining a minimum flow of hydrogen and air to a fuel cell stack, but not actively producing electricity.

Further areas of applicability of the teachings of the present application will become apparent from the detailed description, claims and the drawings provided hereinafter, wherein like reference numerals refer to like features throughout the several views of the drawings. It should be understood that the detailed description, including disclosed embodiments and drawings referenced therein, are merely exemplary in nature intended for purposes of illustration only and are not intended to limit the scope of the present disclosure, its application or uses. Thus, variations that do not depart from the gist of the present application are intended to be within the scope of the present application.

### BRIEF DESCRIPTION OF THE DRAWINGS

FIG. 1A-1B are functional block diagrams of a fuel cell electric vehicle (FCEV) including a hydrogen fuel cell system with a standby mode and an example control system according to the principles of the present application;

FIGS. 2A-2B are functional block diagrams of an example system architecture for the control system and an example plot of operation of the control system according to the principles of the present application; and

FIG. 3 is a flow diagram of an example control method improving energy efficiency during regeneration in an FCEV according to the principles of the present application.

### DESCRIPTION

As previously discussed, some fuel cell electric vehicles (FCEVs) are configured such that a fuel cell system generates electrical energy for supporting a high voltage bus and recharging a high voltage battery system. The high voltage battery system is also configured to be recharged during regeneration operation (i.e., coasting/braking regeneration) where the kinetic energy of the FCEV is configured to be converted back into electrical energy (e.g., via a motor-generator unit, or MGU). Thus, instances could arise where the kinetic energy of the FCEV cannot be fully obtained during a regeneration event due to the fuel cell system charging the high voltage battery system at or near its maximum capacity or state of charge (SOC). Conventional fuel cell systems, however, are not configured to be quickly turned on/off or to quickly have their output power reduced, as there are startup/shutdown procedures and excessive on/off operations could damage or degrade the fuel cell stack membranes over time. Thus, an opportunity for improvement exists in the relevant art.

Accordingly, techniques are presented herein that leverage a standby mode present on newer fuel cell systems. This standby mode involves the fuel cell system remaining partially operational (i.e., a minimum flow of hydrogen and air to the fuel cell stack) but not actively producing electricity. From this standby mode, the fuel cell system can be rapidly started (transitioned to an on/run mode). Transitioning between the run and standby modes is controlled based on the regeneration state of the FCEV, the high voltage battery system SOC, and other parameters. While particularly applicable to fuel cell systems having this standby mode, it will be appreciated that techniques could be applicable to scenarios when the standby mode is unavailable or to conventional fuel cell systems that do not have a standby mode. As mentioned above, in such conventional fuel cell systems, there are a limited number of on/off transitions that are allowable.

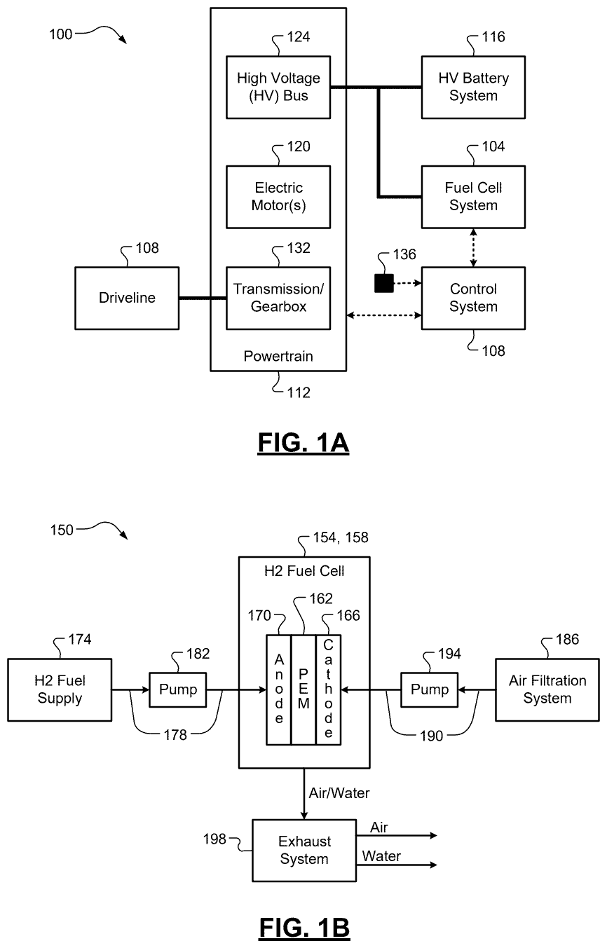

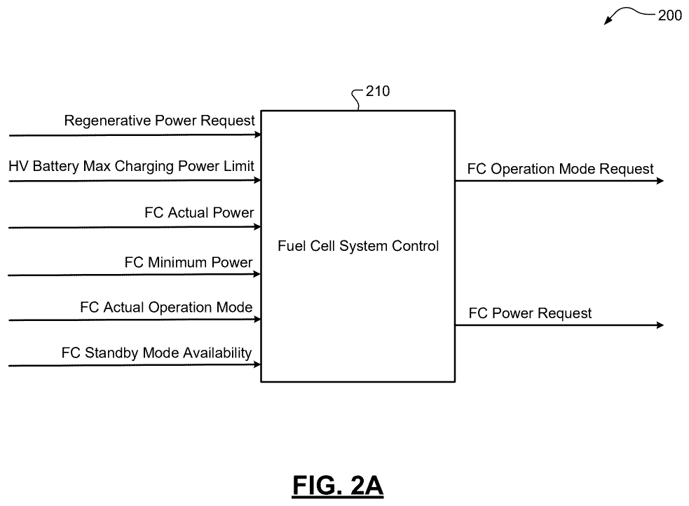

Referring now to FIGS. 1A-1B, functional block diagrams of an FCEV 100 including a fuel cell system 104 with a standby mode and an example control system 108 according to the principles of the present application are illustrated. The FCEV 100 generally comprises an electrified powertrain 112 that includes the fuel cell system 104, a high voltage battery pack or system 116, and at least one electric motor 120. The electric motor(s) 120 are powered by electrical energy via a high voltage bus 124 and are configured to generate drive torque that is transferred to a driveline 128 via an optional transmission or gearbox 132. At least one of the electric motor(s) 120 is also associated with an MGU 136, which converts kinetic energy at the respective electric motor(s) 120 to electrical energy for supporting the high voltage bus 124 and, in some cases, recharging the high voltage battery system 116. The fuel cell system 104 is also configured to selectively generate electrical energy (e.g., 200V DC), which can be boosted to a higher voltage (e.g., 400V DC) corresponding to the high voltage bus 124. A plurality of sensors 136 are configured to measure or monitor various operating parameters of the FCEV 100, including, but not limited to, a state of charge (SOC) of the high voltage battery system 116, parameters of the fuel cell system 104, and a regenerative power request (e.g., based on a driver torque request and a kinetic energy of the FCEV 100).

The control system 108 controls operation of the FCEV 100, including controlling the fuel cell system 104 as described in greater detail below. FIG. 1B illustrates an example configuration 150 of the fuel cell system 104 according to the principles of the present application. As shown, the fuel cell system 104 can be a hydrogen (H2) fuel cell system, but it will be appreciated that different fuel types could be utilized. The fuel cell system 104 comprises a fuel cell stack 154 that includes at least one H2 fuel cell 158 (also “fuel cell 158”). While a single fuel cell 158 is shown for simplicity, it will be appreciated that the fuel cell stack 154 could include a plurality of fuel cells 158 stacked together. The H2 fuel cell 158 includes a polymer electrolyte membrane (PEM) 162 that is sandwiched between a positive electrode or cathode 166 and a negative electrode or anode 170. H2 fuel is introduced to the anode 170, and oxygen (O2) from air is introduced to the cathode 166. The H2 molecules break apart into protons and electrons due to an electrochemical reaction in a catalyst of the H2 fuel cell 158. The electrons travel through external circuitry (thereby providing electricity) and later recombine with the protons at the cathode 166 where the protons, electrons, and O2 combine to form water.

Hydrogen or H2 fuel is selectively provided from a H2 storage tank 174 and to the H2 fuel cell 158 via an H2 supply line 178 and a H2 supply pump 182. Fresh air (including O2) is also selectively provided from an existing or separate air filtration system 186 to the H2 fuel cell 158 via an air supply line 190 and an air supply pump 194. Finally, exhaust (water and air) is expelled from the fuel cell 158 to an exhaust system 198 that is configured to separate the water from the air. During the above-mentioned standby mode, the H2 fuel cell system 150 is operated at a partial operation state where the H2 fuel cell 158 is not actively generating electricity, but also remains capable of quickly switching on to produce electricity when needed. In this partial operation state, minimum H2 fuel is consumed (e.g., the H2 fuel supply pump 182 and the air supply pump 194 are operated at a minimum operating speed for the standby mode). Thus, the H2 fuel cell 158 could still be producing some electricity, but this could be an insubstantial amount of electricity that could be dissipated or otherwise used/consumed.

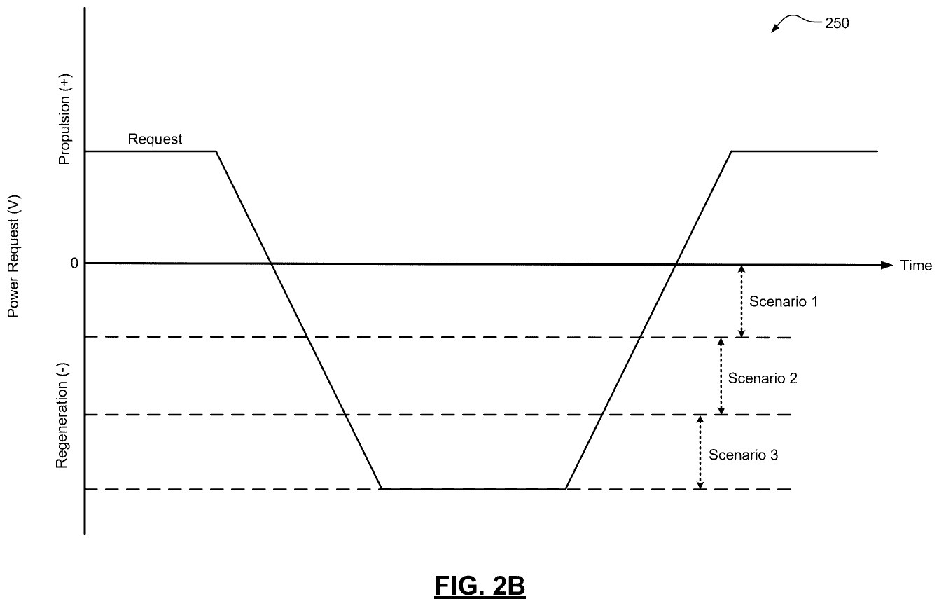

Referring now to FIGS. 2A-2B and with continued reference to FIGS. 1A-1B, functional block diagrams of an example system architecture 200 for the control system 108 and an example plot 250 of operation of the control system 108 according to the principles of the present application are illustrated. In FIG. 2A, the example system architecture 200 includes a fuel cell system control block 210 that generates and outputs an operation mode request for the fuel cell (FC) system 104 (RUN/ON, STANDBY, or OFF)and a power request for the fuel cell system 104 (P_{FC_Req}) based on a plurality of inputs. As shown, these inputs include, but are not necessarily limited to, a regenerative power request (P_{Regen}), a maximum (max) charging power limit for the high voltage (HV) battery system 116 (P_{Batt_Max}), an actual or current power of the fuel cell system 104 (P_{FC_Actual}), a minimum power for the fuel cell system 104 (P_{FC_Min}), an actual or current operation mode of the fuel cell system 104, and a standby mode availability for the fuel cell system 104. The regenerative power request is calculated based on a combination of requested coasting and braking regeneration. The high voltage battery system maximum charging power limit is a maximum allowed charging power limit into the high voltage battery system 116. The fuel cell minimum power is a minimum power that the fuel cell system 104 can maintain in the ON/RUN mode without shutoff.

Based on these inputs, if the power request for the fuel cell system 104 and/or its operation mode need to be changed in order to prioritize and maximize the regenerative power, the fuel cell system control block 210 will control the fuel cell system 104 to a certain power (the fuel cell power request) and operation mode (the fuel cell system operation mode request) in one of three difference scenarios as illustrated in the plot 250 of FIG. 2B. In a first scenario (Scenario 1), both the fuel cell power and operation mode requests are to be maintained the same as before if all regenerative power can be fully absorbed by the high voltage battery system 116 (P_{Regen}≤P_{Batt_Max}−P_{FC_Actual}). In a second scenario (Scenario 2), the fuel cell power request is to be reduced and the operation mode request (RUN) is to be maintained the same as before if the regenerative power cannot be fully absorbed by the high voltage battery system (P_{Batt_Max}−P_{FC_Actual}<P_{Regen}≤P_{Batt_Max}−P_{FC_Min}+P_{TH}), where P_{TH} is a power threshold). The introduction of this power threshold P_{TH} is for considering the cost factors of changing the operation mode of the fuel cell system 104. When this condition is met, the fuel cell power request will be reduced as follows: P_{FC_Min}≤P_{FC_Req}=(P_{Batt_Max}−P_{Regen}). In a third scenario (Scenario 3), both the fuel cell power request and the fuel cell operation mode request are to be changed to reduce the fuel cell power to zero (e.g., 0 kilowatts, or kW) and the operation mode will be changed to STANDBY or OFF when P_{Regen}>(P_{Batt_Max}−P_{FC_Min}+P_{TH}). When this condition is met, the fuel cell power request will be reduced to zero (or approximately zero during STANDBY mode) and the operation mode request will be changed to STANDBY mode (if STANDBY mode is currently available) or otherwise to OFF.

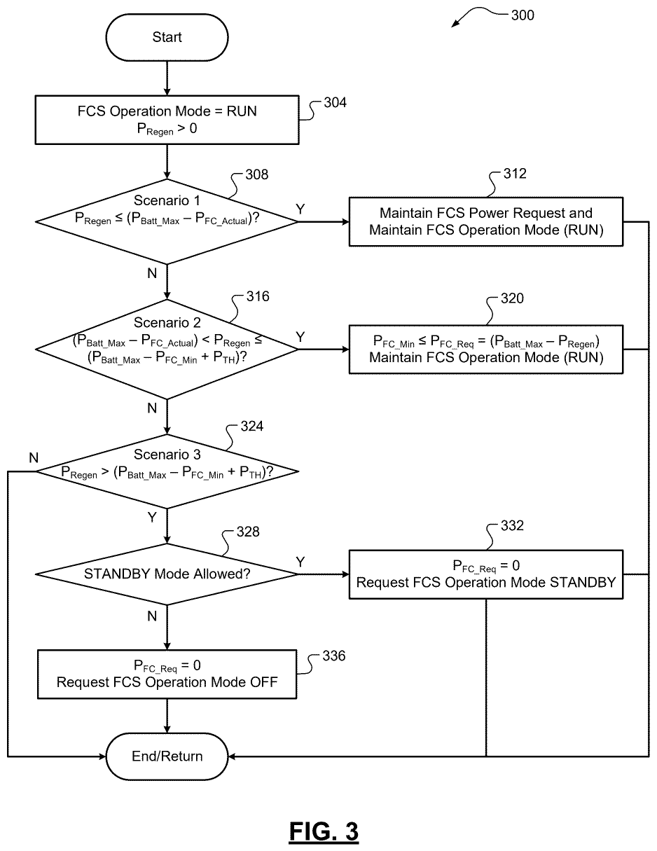

Referring now to FIG. 3 and with continued reference to the previous figures, a flow diagram of an example method 300 for improving energy efficiency during regeneration in an FCEV according to the principles of the present application is illustrated. While the method 300 specifically references the FCEV 100 and its components, it will be appreciated that the method 300 could be applicable to any suitably configured FCEV, even including FCEVs having conventional fuel cell systems without a standby mode. The method 300 begins at 304 where the operation mode of the fuel cell system (FCS) 104 is RUN/ON and the regenerative power request P_{Regen} is greater than zero. It will be appreciated that while shown as a negative value (Regeneration) in FIG. 2B, P_{Regen} for purposes of FIG. 3 is converted to a positive value. This step 304 could also include the control system 108 verifying that certain preconditions are satisfied, such as, but not limited to, there being no malfunctions or faults present that would negatively impact or otherwise inhibit the techniques of the present application. At 308, the control system 108 determines whether the first scenario (Scenario 1) is present, which corresponds to P_{Regen}≤(P_{Batt_Max}−P_{FC_Actual}). When true, the method 300 proceeds to 312. When false, the method 300 proceeds to 316. At 312, the control system 108 maintains the FCS power request and the current operation mode (RUN) and the method 300 then ends or returns to 304.

At 316, the control system 108 determines whether the second scenario (Scenario 2) is present, which corresponds to P_{Batt_Max}−P_{FC_Actual}<P_{Regen}≤P_{Batt_Max}−P_{FC_Min}+P_{TH}. When true, the method 300 proceeds to 320. When false, the method 300 proceeds to 324. At 320, the control system 108 reduces the FCS power request to P_{FC_Min}≤P_{FC_Req}=P_{Batt_Max}−P_{Regen} and maintains the current operation mode (RUN) and the method 300 ends or returns to 304. At 324, the control system 108 determines whether the third scenario (Scenario 3) is present, which corresponds to P_{Regen}>P_{Batt_Max}−P_{FC_Min}+P_{TH}. When true, the method 300 proceeds to 328. When false, the method 300 ends or returns to 304. At 328, the control system 108 determines whether the STANDBY mode for the fuel cell system 104 is currently available. When true, the method 300 proceeds to 332. When false, the method 300 proceeds to 336. At 332, the control system 108 reduces the FCS power request to zero (or approximately zero, e.g., slightly greater than zero) and the FCS operation mode request is changed to STANDBY, thereby allowing for a faster transition back to the RUN/ON mode when needed, and the method 300 then ends or returns to 304. At 336, the control system 108 reduces the FCS power request to zero and the FCS operation mode request is changed to OFF and the method 300 then ends or returns to 304.

It will be appreciated that the terms “controller” and “control system” as used herein refers to any suitable control device or set of multiple control devices that is/are configured to perform at least a portion of the techniques of the present application. Non-limiting examples include an application-specific integrated circuit (ASIC), one or more processors and a non-transitory memory having instructions stored thereon that, when executed by the one or more processors, cause the controller to perform a set of operations corresponding to at least a portion of the techniques of the present application. The one or more processors could be either a single processor or two or more processors operating in a parallel or distributed architecture.

It should also be understood that the mixing and matching of features, elements, methodologies and/or functions between various examples may be expressly contemplated herein so that one skilled in the art would appreciate from the present teachings that features, elements and/or functions of one example may be incorporated into another example as appropriate, unless described otherwise above.

What is claimed is:

1. A fuel cell control system for a fuel cell electric vehicle (FCEV) including a fuel cell system and a high voltage battery system, the fuel cell control system comprising:
a set of sensors configured to determine a regenerative power request for the FCEV, wherein the regenerative power request corresponds to kinetic energy of the FCEV being converted into electrical energy via a motor-generator unit (MGU) of the FCEV; and
a control system configured to:
compare the regenerative power request to a plurality of power limits associated with operation of the fuel cell system, wherein the fuel cell system is configured to operate in each of run, standby, and off operation modes; and
when the regenerative power request exceeds the plurality of power limits, reduce a power request for the fuel cell system to zero and command an operation mode request for the fuel cell system to change from run to standby.

2. The fuel cell control system of claim 1, wherein the control system is further configured to determine whether the standby operation mode of the fuel cell system is currently available.

3. The fuel cell control system of claim 2, wherein the control system is further configured to, when the standby operation mode of the fuel cell system is not currently available and the regenerative power request exceeds the plurality of power limits, reduce the power request for the fuel cell system to zero and command the operation mode request for the fuel cell system to change from run to off.

4. The fuel cell control system of claim 1, wherein the plurality of power limits are each based on a combination of at least two of (i) a maximum charging power limit for the high voltage battery system, (ii) an actual power generated by the fuel cell system, (iii) a minimum power limit to be generated by the fuel cell system, and (iv) a mode transition power cost threshold.

5. The fuel cell control system of claim 4, wherein the control system is configured to initially operate the fuel cell system in the run operation mode with a power request greater than zero.

6. The fuel cell control system of claim 5, wherein the control system is further configured to, when the regenerative power request is less than or equal to a first power difference between the maximum charging power limit for the high voltage battery system and the actual power generated by the fuel cell system, maintain the power request and the run operation mode of the fuel cell system.

7. The fuel cell control system of claim 6, wherein the control system is further configured to, when the regenerative power request is (i) greater than the first power difference and (i) less than or equal to a sum of the first power difference and the mode transition power cost threshold, maintain the run operation mode of the fuel cell system and reduce the power request for the fuel cell system to a second power difference between the maximum charging power limit for the high voltage battery system and the regenerative power request.

8. The fuel cell control system of claim 7, wherein the control system is further configured to, when the regenerative power request is greater than a sum of the first power difference and the mode transition power cost threshold, reduce the power request for the fuel cell system to zero and change the operation mode request for the fuel cell system from run to standby or off based on an availability of the standby operation mode.

9. The fuel cell control system of claim 1, wherein the standby operation mode of the fuel cell system involves the fuel cell system remaining partially operational, by maintaining a minimum flow of hydrogen and air to a fuel cell stack, but not actively producing electricity.

10. A control method for a fuel cell electric vehicle (FCEV) including a fuel cell system and a high voltage battery system, the control method comprising:
providing a set of sensors configured to determine a regenerative power request for the FCEV, wherein the regenerative power request corresponds to kinetic energy of the FCEV being converted into electrical energy via a motor-generator unit (MGU) of the FCEV;
comparing, by a control system of the FCEV, the regenerative power request to a plurality of power limits associated with operation of the fuel cell system, wherein the fuel cell system is configured to operate in each of run, standby, and off operation modes; and
when the regenerative power request exceeds the plurality of power limits, reducing, by the control system, a power request for the fuel cell system to zero and commanding, by the control system, an operation mode request for the fuel cell system to change from run to standby.

11. The control method of claim 10, further comprising determining, by the control system, whether the standby operation mode of the fuel cell system is currently available.

12. The control method of claim 11, further comprising when the standby operation mode of the fuel cell system is not currently available and the regenerative power request exceeds the plurality of power limits, reducing, by the control system, the power request for the fuel cell system to zero and commanding, by the control system, the operation mode request for the fuel cell system to change from run to off.

13. The control method of claim 10, wherein the plurality of power limits are each based on a combination of at least two of (i) a maximum charging power limit for the high voltage battery system, (ii) an actual power generated by the fuel cell system, (iii) a minimum power limit to be generated by the fuel cell system, and (iv) a mode transition power cost threshold.

14. The control method of claim 13, further comprising initially operating, by the control system, the fuel cell system in the run operation mode with a power request greater than zero.

15. The control method of claim 14, further comprising when the regenerative power request is less than or equal to a first power difference between the maximum charging power limit for the high voltage battery system and the actual power generated by the fuel cell system, maintaining, by the control system, the power request and the run operation mode of the fuel cell system.

16. The control method of claim 15, further comprising when the regenerative power request is (i) greater than the first power difference and (i) less than or equal to a sum of the first power difference and the mode transition power cost threshold, maintaining, by the control system, the run operation mode of the fuel cell system and reducing, by the control system, the power request for the fuel cell system to a second power difference between the maximum charging power limit for the high voltage battery system and the regenerative power request.

17. The control method of claim 16, further comprising when the regenerative power request is greater than a sum of the first power difference and the mode transition power cost threshold, reducing, by the control system, the power request for the fuel cell system to zero and changing, by the control system, the operation mode request for the fuel cell system from run to standby or off based on an availability of the standby operation mode.

18. The control. method of claim 10, wherein the standby operation mode of the fuel cell system involves the fuel cell system remaining partially operational, by maintaining a minimum flow of hydrogen and air to a fuel cell stack, but not actively producing electricity.
